(19) United States
(12) Patent Application Publication
(10) Pub. No.: US 2007/0033214 A1
(43) Pub. Date: Feb. 8, 2007

(54) Visual identifiers for digital data

(75) Inventors: John Lewis, Rowland Heights, CA (US); Ruth E. Rosenholtz, Cambridge, MA (US); Nickson Fong, Singapore (SG); Ulrich Neumann, Manhattan Beach, CA (US)

Correspondence Address: INTELLECTUAL PROPERTY LAW GROUP LLP, 12 SOUTH FIRST STREET, SUITE 1205, SAN JOSE, CA, 95113, US

(73) Assignee: Egg Story Creative Production Pte, Ltd

(21) Appl. No.: 11/197,840

(22) Filed: Aug. 5, 2005

(51) Int. Cl. G06F 7/00

(52) U.S. Cl. 707/102

(57) ABSTRACT

A method of generating a pictorial identifier for a computer object. The method comprises generating a pictorial identifier according to a modelling approach. The modelling approach is based on at least a part of a textual identifier of the computer object wherein the part of the textual identifier is not tied to any type identifiers associated with the computer object and the modelling approach is generally characterised by generating pictorial identifiers being visually different from pictorial identifiers generated from substantially different textual identifiers.

### BACKGROUND OF THE INVENTION

1. Field of the Invention

The present invention relates to visual identifiers for digital data. In one application the invention provides a method of generating a pictorial identifier associated with a computer object in a computer system. Other methods and systems are provided.

2. Background Art

The following discussion of the background of the invention is intended to facilitate an understanding of the invention. It should be appreciated that the discussion is not an acknowledgment or admission that any of the material referred to was published, known or part of the common general knowledge of the person skilled in the art in any jurisdiction as at the priority date of the application.

Numerous studies have shown that in a graphical user interface users can often misplace files and have trouble navigating through a variety of commands and data storage structures. This problem has been called the “lost in hyperspace” problem and is the subject of a number of alternative graphical user interfaces.

Furthermore, many people have trouble locating files in systems which they visit regularly. One empirical study even describes someone trying to find a file that they had created earlier the same day. Other studies have show that users generally have trouble establishing a sense of place.

Sophisticated navigation mechanisms addressing impaired way finding and place blindness have been addressed most often by focus plus context approaches in which a warped view differentially enlarges the focus region while displaying much or all of the entire space at a smaller scale. These approaches include both distorted presentations such as fisheye views and the use of simulated perspectives to diminish distant objects.

Such sophisticated navigation systems do not entirely address the problem of objects becoming lost in hyperspace. For example, if the space is both large and relatively featureless, then showing the surrounding context will not entirely eliminate place blindness. Furthermore, the problem is only exacerbated in fisheye and other distorted views wherein a changing focal point can result in large or even drastic changes to the display.

Other systems employ visual thumbnails showing a diminished view of the front page of a number of documents. Thumbnails are mainly effective for some forms of image data, and one recall test has even found that document thumbnails are no more effective than generic icons.

It is an object of the invention to provide the public with improved methods and systems which assist in navigation or, at the very least, provide the public with a useful choice.

### SUMMARY OF THE INVENTION

According to a first aspect of the invention there is provided a method of generating a pictorial identifier for a computer object, the method comprising: generating a pictorial identifier according to a modelling approach based on at least a part of a textual identifier of the computer object; wherein the part of the textual identifier is not tied to any type identifiers associated with the computer object and the modelling approach is generally characterised by generating pictorial identifiers that are visually different from pictorial identifiers generated from substantially different textual identifiers.

Preferably the modelling approach is generally characterised by generating pictorial identifiers resembling pictorial identifiers generated from substantially similar textual identifiers. In these arrangements the level of similarity between textual identifiers needed to generate a similar pictorial identifier is preferably controlled by an adjustable threshold.

The part of the textual identifier may comprise part of a name identifier of the computer object and/or part of the content of the computer object, said parts not being tied to a type identifier associated with the computer object. The content of the computer object may include the time stamp, author, number of words and other identifiers.

In arrangements of the invention it is possible to provide a fundamentally different approach to the lost in computer space problem. By providing a pictorial identifier that is characterised by resembling pictorial identifiers generated from substantially similar textual identifiers and being visually different from a pictorial identifiers generated from substantially different textual identifiers the visual skills of the user can be exploited to provide an improved navigation system. Embodiments provide substantial benefits over standard generic pictorial icons and textual identifiers. Pictorial identifiers may include drawings, doodles, and pictures.

Preferably the modelling approach is based on the part of the name identifier as well as a part of the name identifier tied to a type identifier associated with the computer object. This preferably allows for pictorial identifiers to be distinguished on the basis of both file types associated with the computer object and those parts of the name identifier not tied to a file type. In these embodiments the pictorial identifier for a particular computer object is easily visually distinguishable from those of other computer object of with different identifiers or file types.

Preferably the modelling approach involves determining which computer applications are associated with the type identifier so that the similarity arising from name identifiers being tied to type identifiers associated with similar computer applications is recognised by the modelling approach. The type identifiers may be tied to one or more computer applications.

Preferably determining which computer applications are associated with the type identifier includes querying a file type association module.

Preferably the modelling approach is based on the entire name identifier, in the common case of computer objects with an assigned name. In these arrangements each name identifier is attributed a distinctive appearance in the pictorial identifier. The name identifier is selected in preference to other possible data attributes because the name embodies the role and meaning of the object from the user's point of view. The modelling approach exploits this to allow computer objects with similar names and hence similar roles and meanings, to have similar pictorial identifiers.

Preferably the method includes proactively generating pictorial identifiers for a plurality of computer objects according to the modelling approach, upon name identifiers of computer objects being modified or created.

Preferably the method includes generating pictorial identifiers for a plurality of computer objects according to the modelling approach, upon the user opening a directory structure containing the objects.

Preferably the modelling approach is further characterised by generating pictorial identifiers of intermediate complexity.

Preferably the modelling approach is further characterised by generating pictorial identifiers that are distinctive on an overview scale as well as a thumbnail scale.

Preferably the method includes sorting a plurality of name identifiers into sub-groups according to the similarity of the textual identifiers, the modelling approach being additionally based on the structure of the sub-groups.

Preferably sorting involves determining the closest match among the textual identifiers and creating a new sub-group if the distance between the closest match and the textual identifier is greater than a threshold. The distance is preferably calculated using a distance calculation module.

Preferably generating involves mutating a pictorial identifier associated with the sub-group into which the textual identifier of the computer object has been sorted. Preferably all pictorial identifiers in a subgroup are generated from or comprise a base pictorial identifier.

Preferably the modelling approach is further characterised by generating pictorial identifiers such that they comprise a plurality of line segments. The modelling approach may be based on a scribble algorithm.

Preferably the computer object is a computer file and the pictorial identifier provides an icon for representing the computer file in a graphical user interface. In other arrangements the computer object may, for example, be a hyperlink in a computer file pointing to another file.

According to a second aspect of the invention there is provided a method of associating a pictorial identifier with a computer object comprising:
processing at least a part of a name identifier of the computer object, wherein the part of the name identifier is not tied to any type identifiers associated with the computer object; and
associating a pictorial identifier with the computer object such that the pictorial identifier is visually different from pictorial identifiers associated with substantially different name identifiers of other computer objects.

Preferably the modelling approach is based on the part of the name identifier as well as a part of the name identifier tied to a type identifier associated with the computer object.

Preferably the pictorial identifier resembles pictorial identifiers associated with substantially similar textual identifiers of yet other computer objects and the level of similarity between textual identifiers needed to generate a similar pictorial identifier is controlled by an adjustable threshold.

Preferably the modelling approach involves determining which computer applications are associated with the type identifier so that the similarity arising from name identifiers being tied to type identifiers associated with similar computer applications is recognised by the modelling approach.

Preferably the modelling approach is based on the entire name identifier.

Preferably the method includes proactively generating pictorial identifiers according to the modelling approach, upon name identifiers of computer objects being modified or created.

Preferably the method includes generating pictorial identifiers for a plurality of computer objects according to the modelling approach, upon the user opening a directory structure containing the objects.

Preferably the modelling approach is further characterised by generating pictorial identifiers such that they comprise a plurality of line segments.

According to a third aspect of the invention there is provided a method of generating a pictorial identifier for a computer object, the method comprising: generating a pictorial identifier according to a modelling approach based on at least a part of a file name preceding a file name extension associated with the computer object, the modelling approach being generally characterised by generating pictorial identifiers resembling pictorial identifiers generated from substantially similar name identifiers and being visually different from pictorial identifiers generated from substantially different name identifiers.

Preferably the file name extension comprises a type identifier consisting of a file name suffix in the form “.*”, where the asterisk represents any number of acceptable characters excluding the period symbol.

Preferably the pictorial identifier is generated based on the entire file name which file name includes the file name extension.

Preferably sorting a plurality of name identifiers into sub-groups according to the similarity of the name identifiers, the modelling approach being additionally based on the structure of the sub-groups.

Preferably the method includes sorting involves determining the closest match among the name identifiers and creating a new sub-group if the distance between the closest match and the name identifier is greater than a threshold.

Preferably generating involves mutating a pictorial identifier associated with the sub-group into which the name identifier of the computer object has been sorted.

According to a fourth aspect of the invention there is provided a method comprising: providing a pictorial identifier generated according to a modelling approach based on at least a part of a name identifier of the computer object; wherein the part of the name identifier is not tied to any type identifiers associated with the computer object and the modelling approach is generally characterised by generating pictorial identifiers resembling pictorial identifiers generated from substantially similar name identifiers and being visually different from pictorial identifiers generated from substantially different name identifiers. Preferably the pictorial identifier is provided on a display.

Preferably the method includes sorting a plurality of name identifiers into sub-groups according to the similarity of the name identifiers, the modelling approach being additionally based on the structure of the sub-groups.

Preferably the sorting involves determining the closest match among the name identifiers and creating a new sub-group if the distance between the closest match and the name identifier is greater than a threshold.

According to a fifth aspect of the invention there is provided a system for generating a pictorial identifier for a computer object, the system comprising:
means for generating a pictorial identifier according to a modelling approach based on at least a part of a name identifier of the computer object, the part of the name identifier not being tied to any type identifiers associated with the computer object; and
means for ensuring that the pictorial identifier generated is visually different from pictorial identifiers generated from substantially different name identifiers.

Preferably the modelling approach is based upon on the part of the name identifier as well as a part of the name identifier tied to a type identifier associated with the computer object.

Preferably the means for ensuring ensures that the pictorial identifier generated resembles pictorial identifiers generated from substantially similar textual identifiers and the system includes threshold means for controlling the level of similarity between textual identifiers needed to generate a similar pictorial identifier, according to an adjustable threshold.

Preferably the system includes means for determining which computer applications are associated with the type identifier so that the similarity arising from name identifiers being tied to type identifiers associated with similar computer applications is recognised by the modelling approach.

Preferably the means for determining comprises means for querying a file type association module.

Preferably the system includes means for proactively generating pictorial identifiers for a plurality of computer objects according to the modelling approach, upon name identifiers of computer objects being modified or created.

Preferably the system includes means for generating pictorial identifiers for a plurality of computer objects according to the modelling approach, upon the user opening a directory structure containing the objects.

Preferably the means for generating is characterised by generating the pictorial identifiers of intermediate complexity.

Preferably the means for generating is characterised by generating pictorial identifiers that are distinctive on a thumbnail scale and an icon scale.

The system may comprise a computer-readable medium such that the means for generating comprises first code means and the means for ensuring comprises second code means. Alternatively the system may further comprise a computer system and means for displaying the pictorial identifier on a display. The system may include a Java system module.

The embodiments described provide scenery as a fait accompli with human visual perception being setup to rapidly learn a somewhat arbitrary mapping between appearance and content.

This is in contradistinction to thumbnail approaches which are not characterised by provided distinctive pictorial identifiers but are rather based on such things as textual content indistinguishable as a thumbnail. Other systems provide only textual identifiers.

According to another aspect of the invention there is provided a method of generating a pictorial identifier for a computer object, the method comprising: generating a pictorial identifier according to a modelling approach based on at least a part of a textual identifier of the computer object; wherein the textual identifier is not tied to any type identifiers associated with the computer object, the modelling approach being characterised by generating differing but visually distinctive identifiers for different computer objects based on the textual identifier.

Preferably the textual identifier comprises an assigned name or a numeric data identifier. Examples of textual identifiers therefore include someone's anonymous health record number or an oil field sensor that dumps data to a numbered database every hour.

Preferably the modelling approach is characterised by generating pictorial identifiers resembling pictorial identifiers generated from substantially similar textual identifiers of computer objects and being visually different from pictorial identifiers generated from substantially different textual identifiers of computer objects.

The modelling approach may be based on the part of the name identifier as well as a part of the name identifier tied to a type identifier associated with the computer object, so that the similarity arising from name identifiers being tied to type identifiers associated with similar computer applications is recognised by the modelling approach.

According to another aspect of the invention there is provided a method of generating a pictorial identifier for a computer object, the method comprising: generating a pictorial identifier according to a modelling approach based on at least a part of a name identifier of the computer object; wherein the part of the name identifier is not tied to any type identifiers associated with the computer object and the modelling approach is generally characterised by generating pictorial identifiers resembling pictorial identifiers generated from substantially similar name identifiers and being visually different from pictorial identifiers generated from substantially different name identifiers.

In arrangements of the invention it is possible to provide a fundamentally different approach to the lost in computer space problem. By providing a pictorial identifier that is characterised by resembling pictorial identifiers generated from substantially similar name identifiers and being visually different from a pictorial identifiers generated from substantially different name identifiers the visual skills of the user can be exploited to provide an improved navigation system. Embodiments provide substantial benefits over standard generic pictorial icons and textual identifiers. Pictorial identifiers may include drawings, doodles, and pictures.

Preferably, the modelling approach is based on the part of the name identifier as well as a part of the name identifier tied to a type identifier associated with the computer object.

Alternate aspects of the invention are directed to the shape grammar methods described herein. These methods are particularly advantageous and the present invention is not to be taken as limited to the other aspects described above.

Throughout the specification, unless the context requires otherwise, the word “comprise” or variations such as “comprises” or “comprising”, will be understood to imply the inclusion of a stated integer or group of integers but not the exclusion of any other integer or group of integers.

### BRIEF DESCRIPTION OF THE DRAWINGS

The invention will be better understood by reference to the following description of several specific embodiments thereof as shown in the accompanying drawings in which:

FIG. 1 is a schematic view illustrating a method according to a first embodiment of the invention;

FIG. 2 is a schematic view of the output of the method illustrated in FIG. 1;

FIG. 3 is a screenshot of a file type association module interface;

FIG. 4 is a schematic view illustrating the method of FIG. 1 in further detail;

FIG. 5 is a further schematic view illustrating the method of FIG. 1 in yet further detail;

FIG. 6 is a schematic view illustrating the method as shown in FIGS. 1 and 5 in further detail;

FIG. 7 is a schematic of a system according to a second preferred embodiment;

FIG. 8 is a schematic view of the output of a prior art system;

FIG. 9 is a schematic view of several structures used in the method of FIG. 1;

FIG. 10 is a screenshot of a graphical user interface according to another embodiment;

FIG. 11 is a schematic view of the output of a method according to a second embodiment of the invention;

FIG. 12 is a schematic view of the output of a method similar to the second embodiment of the invention;

FIG. 13 is a screenshot illustrating an further experiment conducted on an embodiment of the invention;

FIG. 14 is an illustration a memory test conducted on the embodiment of FIG. 13;

FIG. 15 is an illustration of a memory test conducted on another embodiment of the invention;

FIG. 16 shows a database of pictorial identifiers generated according to another embodiment of the invention;

FIG. 17 is another schematic view of the output of a method according to an embodiment of the invention;

FIG. 18 is a further schematic view of the output of a method according to another embodiment of the invention; and

FIG. 19 is an illustration showing a pictorial identifier being generated.

### DETAILED DESCRIPTION OF SPECIFIC EMBODIMENTS

It is to be appreciated that the following discussion is intended to support the present invention. It should be appreciated that the discussion is not an acknowledgement or admission that it is permissible to judge the invention against any of the prior art material disclosed hereunder, or in the specification as a whole.

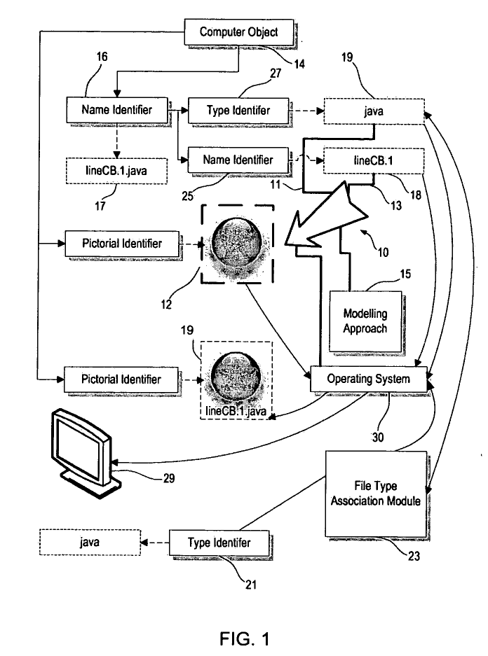

Referring to FIG. 1 there is shown a method 10 of generating a pictorial identifier 12 for a computer object 14. The method 10 includes generating the pictorial identifier 12 according to a modelling approach 15 based on the whole of a name identifier 16 of the computer object 14. As shown in FIG. 1 the whole of the name identifier 16 comprises identifier 17 consisting of the string “lineCB.1.java”. As such the modelling approach 15 is based on a part 18 of the name identifier in combination with a part 19 of the name identifier. This is illustrated by the presence of a connection 11 and a connection 13.

The part 19 is tied to a type identifier 21 associated with the computer object 14 via a file type association module 23. Such an association is understood by virtue of part 19 having the same value “java” as the type identifier 21. In this manner name identifier 16 can be said to include a type identifier 27 comprising part 19. The remaining part 18 of name identifier 18 is understood as comprising another name identifier 25.

According to the method 10 the modelling approach 15 is characterised by the pictorial identifier 12 resembling pictorial identifiers generated from substantially similar name identifiers and being visually different from pictorial identifiers generated from substantially different name identifiers.

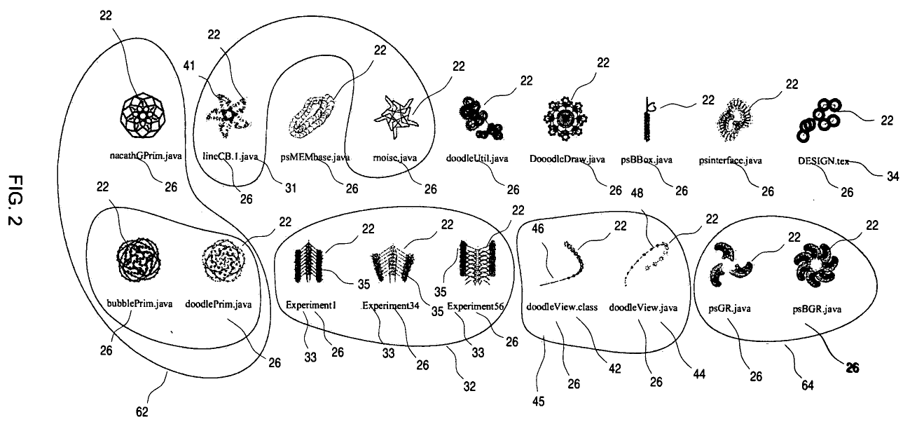

In this connection FIG. 2 shows pictorial identifiers 22 generated from different name identifiers 26 according to a similar embodiment. Each pictorial identifier 22 shown includes a textual representation of its name identifier as does pictorial identifier 19 shown in FIG. 1. The pictorial identifiers 22 are displayed on a display 29 via operating system 30.

It is noted that whilst the modelling approach 15 of FIG. 1 operates on the name identifier 17 comprising the test “lineCB.1.java” to generate the pictorial identifier 12 in the form of a five-pointed star of a particular configuration, the modelling approach 15 as represented in FIG. 2 operates on a name identifier 31, also comprising the string “lineCB.1.java”, to generate a pictorial identifier 41. For ease of reference, the modelling approaches of FIGS. 1 and 2 and pictorial identifiers 12 and 41 are assumed to be the same.

Upon an examination of FIG. 2 it is possible to break the pictorial identifiers 22 into a number of groupings according to which ones of the pictorial identifiers 22 resemble one another and which ones of the pictorial identifiers 22 are visually different. Clearly a first grouping 32, comprising pictorial identifiers 35, is provided where each pictorial identifier 35 shares the quality of resembling a collection of oar like members extending from a central stem. In grouping 32, each of the corresponding computer objects 14 have respective name identifiers 33 of the form “Experiment*”, where the asterisk represents a numeral. As can be seen from the figure each of the name identifiers 33 are structurally very different from the other name identifiers 26. By not having a visible type identifier or a null type identifier, each of the name identifiers 33 is associated with a “null” or blank type identifier via type association module 23. This similarity in the name identifiers 33 provides the similarity of pictorial identifiers 35 in group 32.

The other name identifiers 26 each includes file name type suffixes “tex”, “java” or “class” and as a whole are clearly different. This difference provides the visual differences between pictorial identifiers 35 and the other pictorial identifiers 22.

In the embodiment operating system 30 associates the “java” and “class” identifiers with Java and with Java code file types. The “.tex” identifier 34 is associated with a LaTex publishing format file type. Java is a well-known high-level object orientated programming language and LaTex is a publishing standard.

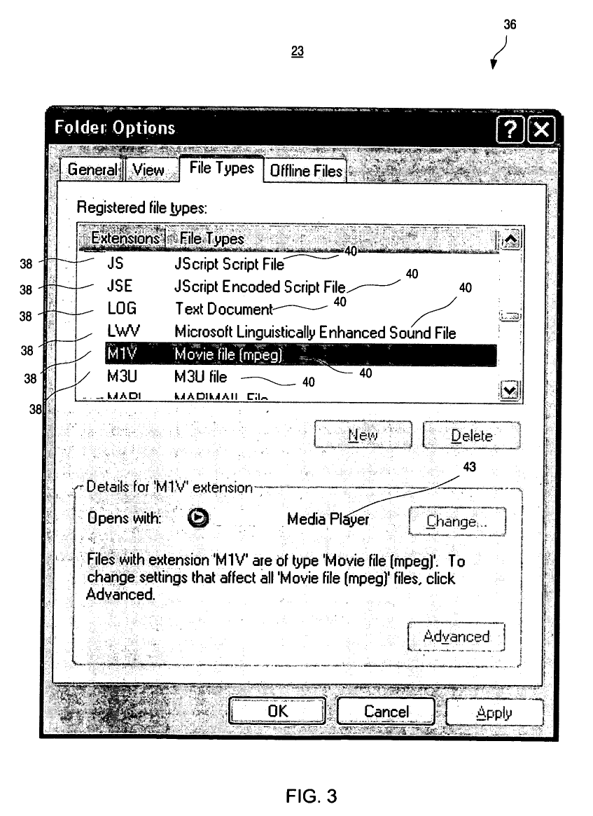

As illustrated in FIG. 3 the file type association module 23 includes a registry interface 36. The registry interface 36 provides access to a registry (not shown) in which each of a plurality of file name suffixes 38, known to the operating system 30 are associated with a number of primary applications 40. For example “M1V” file name suffixes are associated with a Movie file (mpeg) file type which is associated with and a Movie Player Application 43 having name identifier “Media Player”.

In a similar manner “JSE” file name extensions and “JS” file name extensions are respectively associated with Jscript script and JScript encoded script files and a JavaScript host application. The “JSE” file name extensions and “JS” file name extensions are additionally associated with a JavaScript Editing application separate from the JavaScript host application. The registry interface 36 shown in FIG. 3 is based on to a Microsoft Windows interface and is shown only for the purposes of illustration.

In FIG. 2 there is shown a group of pictorial identifiers 22 including name identifiers 42 and 44. Name Identifiers 42 and 44 respectively comprise “doodleView.class” and “doodleView.java” strings and are associated with corresponding pictorial identifiers 46 and 48 which have been generated from name identifiers 42 and 44 by the method 10.

Whilst the pictorial identifiers 46 and 48 resemble each other, they are nonetheless not identical as the type identifiers “class” 57 and “Java” 58, being the suffixes of the name identifiers 42 and 44 have a decided influence on the modelling approach 15.

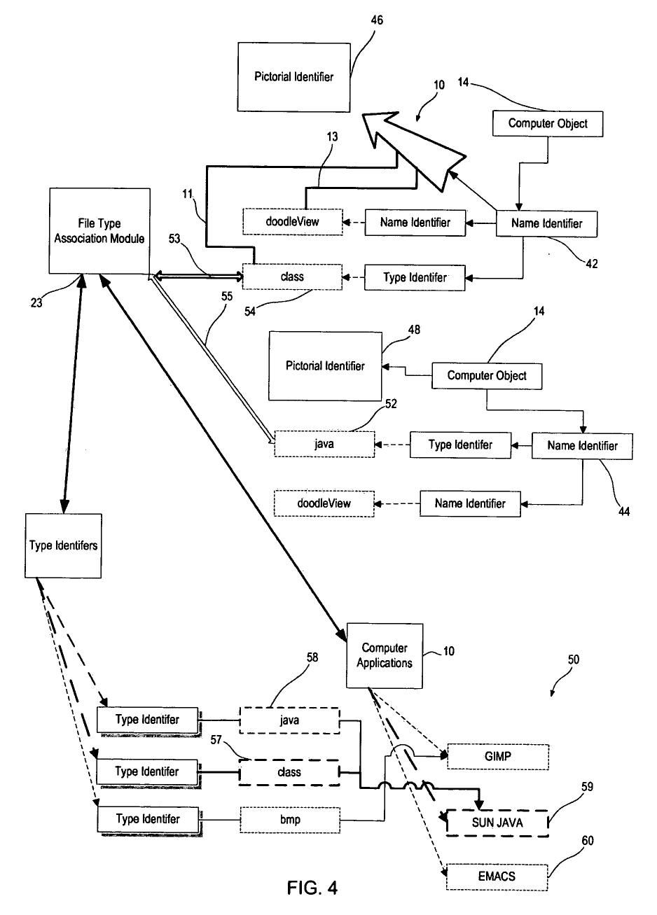

As illustrated in FIG. 4 the generation of the pictorial identifier 46 involves determining which computer applications 50 are associated with the type identifier 52 “class”. This is illustrated by connection 53 connecting type identifier 54 to the file type association module 23. The ensuing querying from the file type association module 23 is shown connecting type identifier 57 to application identifier 59.

Furthermore, the file association module 23 able to determine that both “java” and “class” type identifiers 57 and 58 are associated with computer application “SUN” 59. The modelling approach 10 takes this into consideration when generating pictorial identifier 46 and provides an consequent resemblance in the pictorial identifiers 46 and 48, reflecting the similarity arising from name identifiers 42 and 44 both being tied to type identifiers associated with computer application “Sun” 59. In this name, pictorial identifiers 46 and 48 are more similar that would be the case if say the “class” file type was associated with computer application “Emacs” 60 and not “Sun” 59.

In FIG. 2 a number of other groups are apparent. Group 62 comprises objects 14 having name identifiers of the form “*Prim.java” where an asterisk represents any number of letters. Another group 64 comprises name identifiers of the form “ps?GR.java” where a question mark represents the absence or existence of a character.

Whilst there may be an odd occurrence where an pictorial identifier 22 from a name identifier 26 does not resemble a pictorial identifier 22 from a fairly similar name identifier 26 the modelling approach 15 used in the method 10 nonetheless generally, as in more often than not, serves to achieve providing pictorial identifiers resembling pictorial identifiers generated from substantially similar name identifiers 26, so as to provide a marked improvement to the user. The improvement is discussed in more detail towards the end of this disclosure with examples.

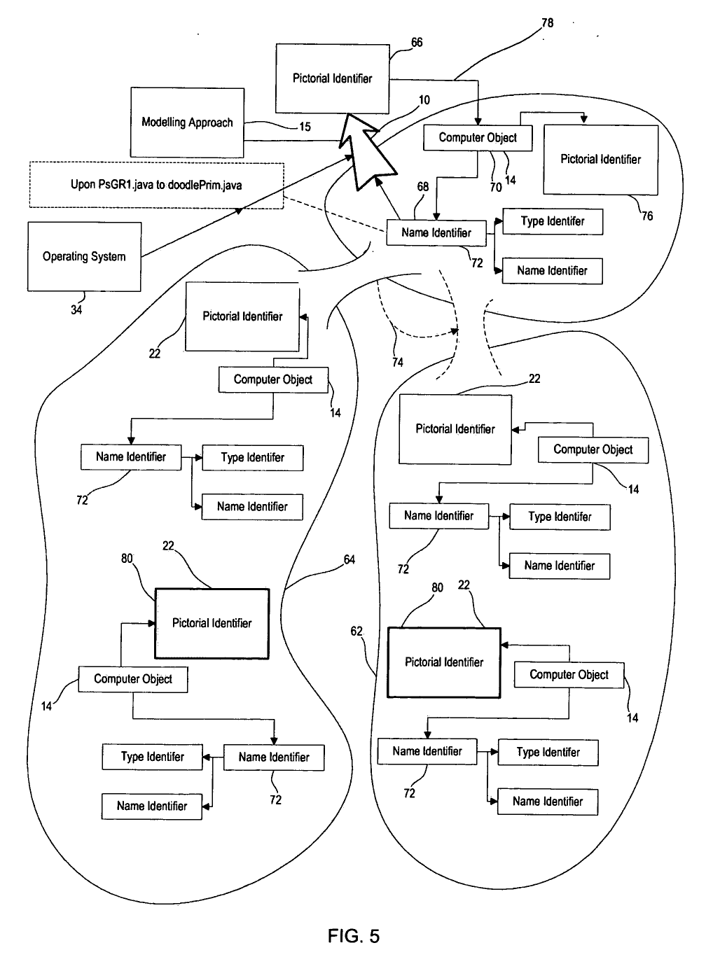

When name identifier 68 is renamed from “psGR1.java” to “doodlePrim.java” the operating system 30 springs into action. Thus, as shown in FIG. 5 the method 10 is configured to proactively generate a pictorial identifier 66 according to the modelling approach 15 upon a name identifier 68 of a computer object 70 being modified or created.

It is to be recognised that in other embodiments no action is proactively taken. Rather the method 10 awaits an instruction from the user to change the pictorial identifier of a computer object. This methodology allows the user to makes use of the mental image of the pictorial identifier already formed in his or her head rather than forcing the user to remember a revised pictorial identifier. Thus in these arrangements a pictorial identifier, or its association with a computer object, is changed only upon instruction from the user.

FIG. 5 illustrates sub-groups 62 and 64 previously mentioned in FIG. 2. Upon the name identifier 66 being renamed from “psGR1.java” the method 10 immediately takes action to sort the name identifiers 72 into the sub-groups according to the similarity of the name identifiers 72. The change of name identifier 68 causes the subgroups 62 and 64 to change as shown by connection 74 being shifted so that computer object 70 moves from being a member of sub-group 64 to being a member of sub-group 62.

In the arrangement of FIG. 5 the modelling approach 15 is based on the structure of the sub-groups by weighting the pictorial identifier 66 according to the relative number of computer objects 14 in each of the groups 62 and 64. This occurs in the level of mutation discussed below.

After creating pictorial identifier 66 the old pictorial identifier 76 associated with computer object 70 is deleted and the new pictorial identifier 66 is associated therewith as identified by connection step 78.

The process of sorting involves determining the closest match among the name identifiers 72 and creating a new sub-group if the distance between the closest match and the name identifier 68 is greater than a threshold. On the modification of name identifier 66 the operating system 30 accordingly performs the following simple algorithm.

Procedure One-level-cluster(Newname)

find the closest match among existing filenames if this distance<threshold then

add newname to the cluster containing closest match else
create new cluster with newname as its only member end

Given that “doodlePrim.java” is similar to “nacathPrim.java” and “BubblePrim.java” there are two close matches from the name identifiers 26 shown in FIG. 2 and a new group does not need to be formed. Rather connection 74 is shifted as described.

The threshold distance can be altered to control the number of clusters created. If desired it can be set to a small number or zero, causing all pictorial identifiers to be as distinct as possible, regardless of the similarity of the corresponding textual identifiers.

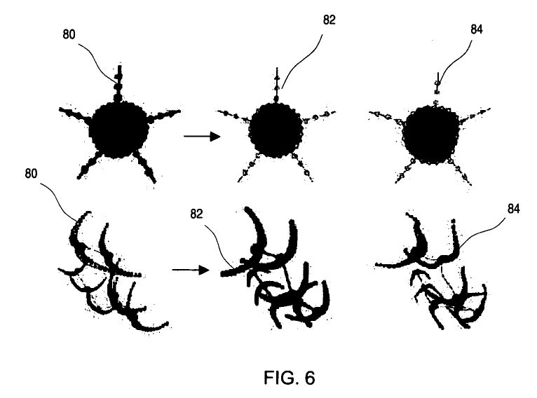

In each of the groups 62, 64 a base pictorial identifier 80 of the pictorial identifiers 22 is associated with the corresponding sub group 62, 64. Each of the other pictorial identifiers in each respective the group 63, 64 is generated by mutating the pictorial identifier 80 of that group. This is illustrated in FIG. 6 wherein base identifiers 80 are respectively mutated into identifiers 82 and 84.

After the pictorial identifiers 22 have been generated and associated with corresponding computer objects 14, the pictorial identifiers 22 are provided on display 29, shown in FIG. 1.

In this embodiment the pictorial identifiers 22 are also generated as required, say upon a user entering a directory structure. The method 10 does however first check to determine whether the generation of the pictorial identifiers 22 is required. If the generation is not required because say the pictorial identifiers are stored in a related directory, no action is taken.

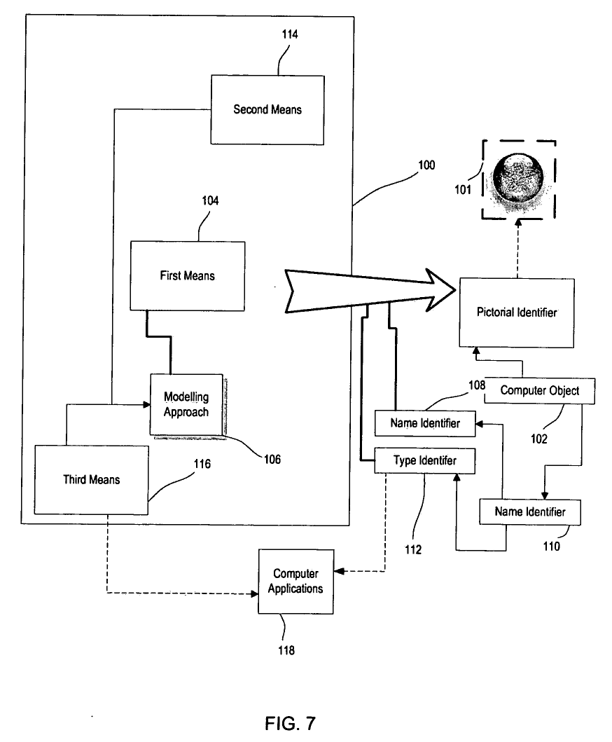

According to another embodiment shown FIG. 7 there is illustrated a system 100 for generating a pictorial identifier 101 for a computer object 102. The system includes means 104 for generating a pictorial identifier according to a modelling approach 106 based on at least a part 108 of a name identifier 110 of the computer object 102, the part 108 of the name identifier 110 not being tied to any type identifiers 112 associated with the computer object 102. Also provided are means 114 for ensuring that the pictorial identifier generated resembles pictorial identifiers generated from substantially similar name identifiers and is visually different from pictorial identifiers generated from substantially different name identifiers. This means 114 accordingly ensures that the pictorial identifiers have the qualities as illustrated in FIG. 2.

The system 10 further includes means 116 for determining which computer applications 118 are associated with the type identifier 112 so that the similarity arising from name identifiers being tied to type identifiers associated with similar computer applications is recognised by the modelling approach. This is illustrated as per FIG. 4.

FIG. 8 shows a number of pictorial identifiers 120 in a UNIX environment. The pictorial identifiers 120 each include a standard icons and are distinguishable only on the basis of folder and file computer object types. On comparing FIG. 2 and 8 it is clear that the pictorial identifiers 22 are each of greater distinctiveness and complexity. It will be clear that the pictorial identifiers 22 are of intermediate complexity and are distinctive on an icon scale and a thumbnail scale.

Mathematically, a simple and approximate definition of complexity is the number of vertices in random polygons.

Various procedural modeling approaches including fractals, solid textures, L-systems are candidates for generating the pictorial identifiers 22. Among these possibilities shape grammars have been successfully applied by the applicant. Although shape grammars have been adopted other approaches might be equally suitable. In this embodiment the modeling approach 15 generates a unique pictorial identifier 22 for every possible name identifier. Furthermore the approach 15 is deterministic in the sense that repeatedly generating a pictorial identifier based on the same name identifier of a computer object will not cause the pictorial identifier to change. Although the pictorial identifiers 22 are in some sense arbitrary, in that there is no immediate correspondence between the pictorial identifiers 22 and the name identifiers 26. The modeling approach 15 will generate the same pictorial identifier for the same name identifier.

The procedure for synthesizing pictorial identifiers 22 starts by identifying similar name identifiers 26 using the sorting algorithm discussed above. Subsequently, the operation of the mutation provides pictorial identifiers 22 that are unique for unique filenames (those not part of a sub-group).

In the process the pictorial identifiers 22 generated are assigned to the name identifier, which in this embodiment comprises the whole file name by using a hash of the filename to seed a pseudorandom generator used in the shape grammar.

For filenames that are members of a sub-group, a hash of the first name added to the sub-group provides the pseudorandom seed used to generate base pictorial identifier 80 for each sub-group. The prototype is then “mutated” to obtain the pictorial identifier for remaining filenames in the subgroup.

A shape grammar consists of a set of shapes (terminals), a set of markers (non-terminals), a set of productions that replace particular configurations of markers (and possibly shapes) with other configurations of shapes (and possibly markers), and a start configuration. Markers are non-drawing shapes that serve to orient and scale productions. A production is applicable when an affine transformation can be found that makes its left side identical to a configuration of markers somewhere in the image. The literature on shape grammars and related techniques is broad and includes many distinct formulations.

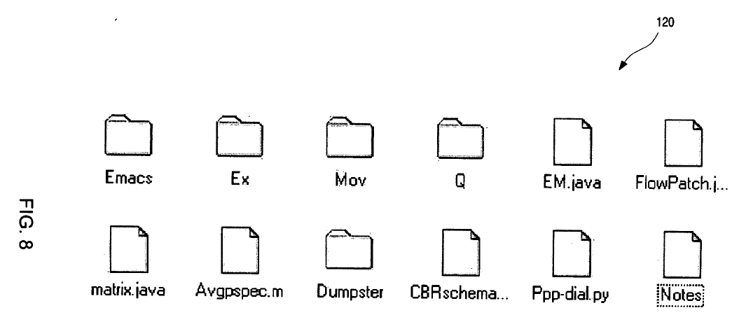

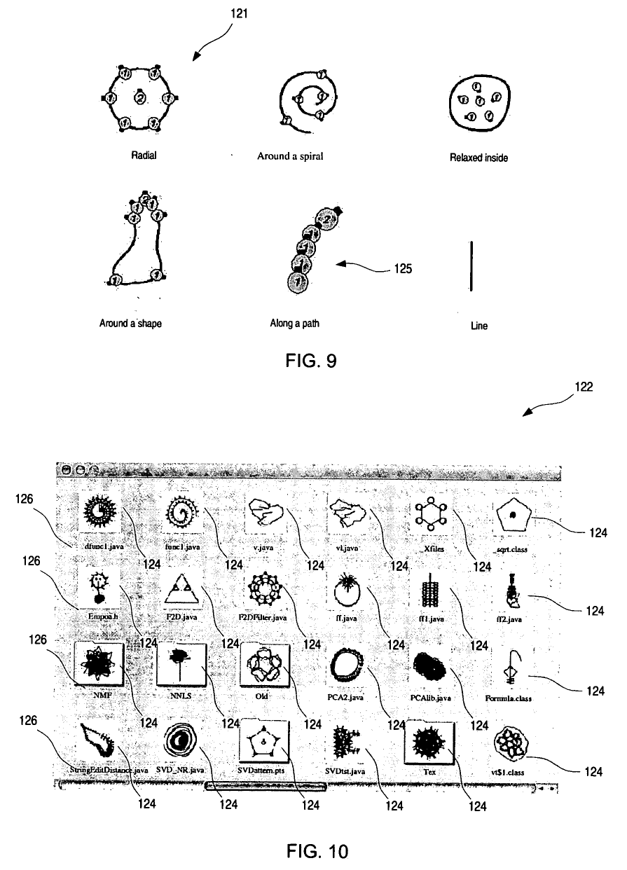

While most work on visual grammars has focused on modeling the properties of specific objects (a particular tiling, or a particular plant species in the case of L-systems), the present embodiment provides a much more diverse range of distinctive shapes. Classic shape grammars allow a marker to be rewritten with any applicable rule, and it is the selection of the particular rule that produces different shapes from the same grammar. As the number of rules increases, the approach of applying rules independently and at random can lead to incoherent collections of parts rather than diverse but coherent patterns. To address this issue, this embodiment advantageously ensures that all instances of a particular marker are rewritten in the same way at each step. Thus, for example, in the radial production of FIG. 9 all of the (1) markers will be replaced with the same derivation.

For reference it is noted that FIG. 9 shows productions in a simple shape grammar. The numbered circles indicate rewrite markers with the tab indicating orientation, and each figure should be imagined as the right side of a production with a single marker on the left hand side.

This restriction having all instances of a particular marker rewritten in the same way at each step can be formalized by adding identifier generation and matching notations. An identifier generator i returns a unique identifier each time it appears. The matching symbol “ ” (underscore) appearing on the left side of a production matches any identifier. With these definitions the grammar can be notated as a tuple (N,T,M,P), where N is the set of nonterminals, T is the set of terminals, M is a set of markers Mᵢ that may be expanded into either non-terminals or terminals, P are the production rules, and M₁ is the start symbol.

A simple grammar using the radial 121 and along-a-path 125 productions comprises
M_→radial (Mᵢ,Mᵢ)
M_→along-a-path(Mᵢ,Mᵢ)
M_→line
M_→null
radial, along-a-path ∈ M, line ∈ T

A sample derivation from this grammar is:
1. M₁→radial(M₂,M₃) (pick the radial production, marker 1 rewritten as M₂, marker 2 rewritten as M₃)
2. M₂→radial(M₄,M₅), M₄→line, M₅→null (M₂ now expanded as a second radial production with its own marker 1 replaced by the line terminal and marker 2 replaced by null)
3. M₃→along-a-path(M₆,M₇), M₆→line, M₇→line (marker 2 of the top level radial expanded as along-a-path with its markers 1, 2 both replaced by the line terminal).

This derivation generates a shape grammar:
M₁→radial (M₂,M₃)
M₂→radial(line,null)
M₃→along-a-path (line,line)

i.e. “an n-gon with n-gons around the perimeter with lines coming off of them, and inside the main n-gon a curving path with lines coming off it.”

A derivation is complete when either every Mᵢ has been rewritten to a terminal, or a user-specified maximum recursion level is reached. The complexity of the derivations can also be approximately controlled. Each generator calculates a complexity estimate as the sum of some intuitively assigned constant value for itself, plus the summed complexities of its children. Derivations more complex than a specified threshold are discarded and replaced by the derivation resulting from an incremented pseudorandom seed. During rendering, lines whose cumulative scaling is smaller than a threshold such as 1.5 pixels are discarded.

Arguably a grammatical formalism is not the simplest explanation of this construction. The construction can also be elegantly expressed using the higher-order function construct in functional languages such as scheme and ML (a higher-order function is a function that returns a function, as distinct from a function that returns a function pointer, as in C++). Scheme pseudocode is provided below for the radial production 121 shown in FIG. 9, omitting the center marker (2) for simplicity (the code corresponding to a production will be termed a “generator” below). This code defines the vertex marker production as some randomly chosen derivation through the grammar (outer lambda, lines 2-6) and then applies this now determined derivation fragment (now represented by the child variable) at the vertex markers (inner lambda, lines 7-12).

| | |
|---|---|
| 1 | (define gen-radial |

| | |
|---|---|
| 2 | (lambda (recursion-level) |

| | |
|---|---|
| 3 | (let ((child (generate-child |

| | |
|---|---|
| 4 | (+ 1 recursion-level))) |

| | |
|---|---|
| 5 | (vc-scale (rndin 0.15 0.7)) |
| 6 | (n (rndin-lowbias 3 12)))) |

| | |
|---|---|
| 7 | (lambda ( ) |

| | |
|---|---|
| 8 | (dotimes (i n) |

| | |
|---|---|
| 9 | (save-ctm |
| 10 | (rotate (/ (* i 2PI) n)) |
| 11 | (scale vc-scale) |
| 12 | (child)))))) |
| 13 | |

| | |
|---|---|
| 14 | (define generate-child |

| | |
|---|---|
| 15 | (lambda (recursion-level) |
| 16 | (let ((child (if (< recursion-level max-level) |

| | |
|---|---|
| 17 | (rnd-pick-child recursion-level) |
| 18 | (rnd-pick-terminal)))) |

| | |
|---|---|
| 19 | (child)))) |

Schema Language shape=grammar psedocode

Note that in calling generate-child the construction is not just randomly picking an applicable predefined production, rather, a particular production is in effect being invented by fixing free parameters of what might be considered a “parameterized production”. The parameters selected in the outer lambda are called “meta” level parameters. The result of the meta-level evaluation is a derivation that may still have some random parameters to be evaluated (in the embodiment these include random parameters that give a “sketch” feel to the individual drawings).

This division of evaluation into a “meta” stage and a second stage involving a more fully specified grammar can also be seen in the formal grammar description above. Whereas grammars are generally defined in terms of fixed symbols, the notations Mᵢ and _ can be viewed as inventing marker symbols and matching them to particular rewrites; the result of evaluating all M and _ is then a grammar with fixed symbols.

With regard to implementation, the simple grammar in FIG. 9 can by itself generate a wide range of patterns. Furthermore implementation is evident as it is a matter of standard graphics programming. The around-a-shape shapes are made using Fourier filtering of noise, thus ensuring periodicity. The along-a-path generator creates a non-periodic random path, also by noise filtering. Most of the pictorial identifiers shown use a grammar that extends the productions in FIG. 9 with additional parameters to add variety, and adds several additional generators. The scribble generator traces the path of a point mass with friction attracted by either random or patterned impulses. The figure generator creates an animal-like arrangement of line generators symmetry calls its child generator with n-lateral radial symmetry.

While the set of generators and their various parameters were intuitively chosen, the particular choice is not crucial to the results. To give a better feel for the types of parameters that were used, the full set of parameters for the radial generator are described next.

The parameter n is the number of vertices in the n-gon. Boolean variables hasVertex, hasMouth control whether the markers at the vertices and in the center will be expanded (markers 1, 2 in FIG. 3). VCscale, MCscale are corresponding scale reduction factors for the respective child generators. mouthOrg is an offset of the center child down from the center of the n-gon (directions are relative to the local coordinate system of the generator). hasEyes places two additional children that might be interpreted as “eyes”. eyeSep is the horizontal separation between these, eyeOrg is the offset of the “eyes” up from the center, and ECscale is their scale reduc-tion. angleCut causes vertex children to appear only within a range of angles from the top of the n-gon, and angleCutOff is the corresponding angular threshold in degrees.

The actual random parameter choices use several random generators each defined in terms of the standard uniform [0,1) pseudo-random generator rnd( ). rndprob(p) returns true if rnd is greater than p. rndin(a,b) returns a random value in [a,b]; both integer and float versions of this routine are used. rndinLowbias(a,b) is similar but is biased toward smaller values by squaring the underlying pseudo-random value (i.e., a+rnd( )2*(b−a)). The parameter choices for radial are:

| | |
|---|---|
| n | rndinLowbias(3, 12) |
| hasVertex | rndprob(0.5) |
| VCscale | rndin(0.15, 0.7) |
| hasMouth | rndprob(0.6) |
| MCscale | rndin(0.1, 0.3) |
| mouthOrg if hasEyes | rndin(−0.2, −0.3) |
| hasEyes | rndprob(0.3) |
| ECscale | rndin(0.1, 0.4) |
| eyeSep | rndin(0.2, 0.3) |
| eyeOrg | rndin(0.2, 0.3) |
| angleCut | rndprob(0.5) |
| angleCutoff | rndin(90, 150) |

Objects with similar names should have similar visual identifiers. A first step toward this goal is to select a pairwise string distance function. Existing procedures such as the Levenshtein edit distance and the (normalized) longest common subsequence are candidates. In this embodiment a variant of normalized common sub-sequence that counts all common subsequences (of length>3), weighted by length is used to determine distance. This choice was motivated by the consideration that the files finalReport.doc and finalRevReport.doc are probably related.

The complete filename distance employs an ad-hoc weighing of this measure computed on the ‘name’ part of the file-name and a binary comparison of the file extension. Since the extension indicates the file type, however, it could be best to directly control the pictorial identifier appearance through grammar parameters or the choice of a grammar rather than participating in the string distance.

Given the string distance, a simple one-level incremental name clustering procedure is adopted that easily maps onto the shape grammar construction. As before the following pseudocode describes the clustering algorithm:

procedure one-level-cluster(newname)

find the closest match among existing filenames
if this distance < threshold then

add newname to the cluster containing closest match

else

create new cluster with newname as its only member

end

To create similar pictorial identifier for similar sorted (clustered) filenames, the pictorial identifier for the first filename in the cluster is “mutated” to create the remaining pictorial identifiers.

In the construction described in relation to FIG. 6 “mutation” is relatively easy. The generated grammars can be walked through and one or more of the embedded parameters changed. The recursive construction provides an approximate ordering in terms of perceptual saliency, in that parameters at the first recursion level generally have larger effects on the image than those at deeper levels. This perceptual ordering is only approximate however, and a more principled approach such as Design Galleries is desirable if suitable output vectors could be determined.

Another issue with this scheme is that the clustering threshold and the amount of variation generated by a “mutation” should be mutually tuned. As a fail safe the user should be able to force generation of new icons if the existing ones are not satisfactory, and the user could have access to some of the parameters of the synthesis procedure.

The design for the shape grammar employed in FIG. 2 was inspired by doodles and reflect a preference for irregular patterns, with lines sometimes rendered in an intentionally sketchy style.

The pictorial identifiers 22 of FIG. 2 show moderately complex icons (maximum recursion level set to 6) generated with this grammar. The diversity of possible shapes is evident.

The compute times for these identifiers 22 range from insignificant to a minute or even more, as some pictorial identifiers contain many thousand short antialiased line segments. On relatively slow computers the generation of the pictorial identifiers is assigned a low priority background task, similar to the file indexing tasks in current operating systems.

Once the pictorial identifiers 22 are available they are associated with corresponding computer objects and are integrated in the user interface.

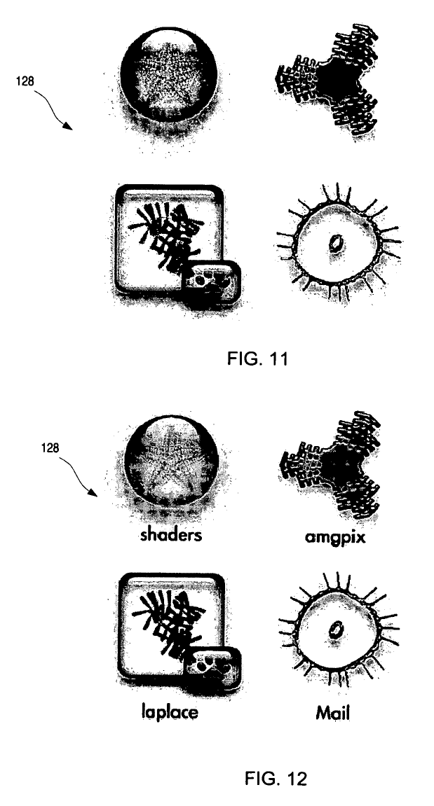

FIG. 10 comprises a screenshot of a simple file browser 122 representing pictorial identifiers as icons 124 with a textual representation of each name identifier 126 there below. The browser 122 includes a Java system module that, upon entering a directory (folder), computes icons for any files that do not already have them. The icons are computed in a separate thread and are stored as small individual images in a subdirectory. Whilst in the browser 118 issues involving the aesthetics of icons 124 are not fully resolved the artificial scenery provided by icons (i) resembling icons generated from substantially similar name identifiers and (ii) visually different from icons generated from substantially different name identifiers, is effective and has shown to be feasible. FIGS. 11 and 12 show several concepts for icon styles 128, included to show two possibilities.

The file browser 122 provides an interface which because of the form of icons 124 is effectively used by humans in many contexts. To verify this several user studies were performed.

Study 1

In the first study, users were asked to find files, specified by filename, in a “file browser” displaying files in a simulated folder, using either distinctive (pictorialID) icons or generic (plain document) icons. A grid of 6×4 files was chosen as representative of a typical number of files in a single folder. In a within-subjects (paired samples) design, each user searched for 2 files, 3 times each, for each type of icon. The order of file targets for each subject was randomly chosen. This repeated search task tests a combination of visual search and short term icon memory: users quickly learn the association between filenames and pictorialIDs and can thus use the pictorialID to aid in search. The study was implemented as a Java applet that uploaded timing data to a server. The 25 users who completed the study required an average of 23.2 seconds to complete the four pictorialID searches, versus 30.5 seconds for the generic-icon searches (paired t-test p=0.029), an improvement of approximately 30%. We would expect an even greater advantage if users were allowed to learn the icons over more than three trials.

The first study did not test pictorialID memory over more than a few minutes, and the file names were specified. Arguably in real life a user tries to find a file based on a memory of the contents of the file, and on vague memory of the file name and location. People are typically not given the file name and told to search for it.

Study 2

In a second study conducted, the aim was for the users to learn a more natural association between the icon and the “contents” of the file, and then to search for a file specified by those contents. Users were first trained using a modified version of the game “Concentration.” Although a game might not seem the most apparent choice, it makes a good substitute for the natural task of working with files and directories as there is no explicit need to memorize the association between the file “contents” and the name or icon. The task can be done entirely by memorizing the locations of the various cards, and would be very similar to what would be true for pictorialIDs. The users would not explicitly memorize the associations.

How users performed under these circumstances was investigated as follows.

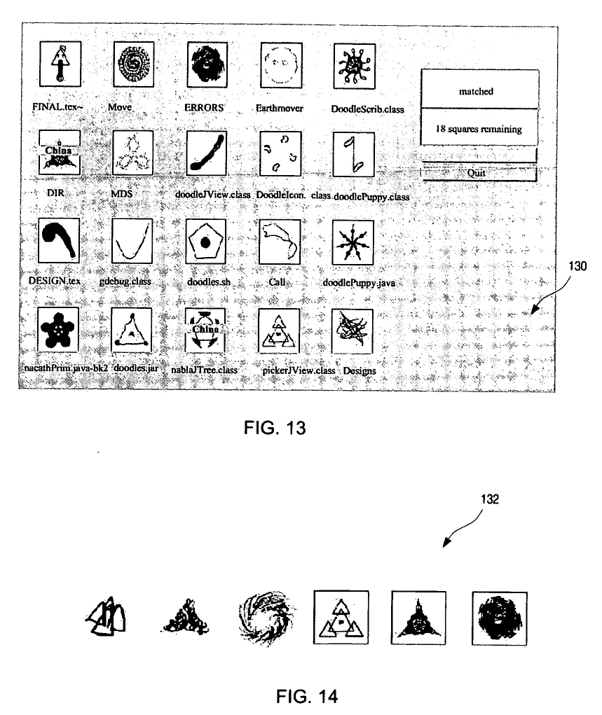

A screenshot 130 of the concentration game is shown in FIG. 13. In the concentration game users viewed a 5×4 array of cards, with either a pictorialID or generic icon on each card, and a file name beneath. Each user saw only one type of icon (pictorialID or generic). When the user clicked on a pair of cards, this revealed the name of a country behind each card. The country thus plays the role of the “content” of the file. The user's goal was to find all 10 matching pairs of countries. For additional training, the user was then asked 25 additional questions such as “Which country is north of the USA? (Click on the pair.).” The next day, users performed a second set of tasks. First, they were shown a series of icons, and asked to pick the associated country in a multiple choice question.

The 21 users who completed both days were 37% correct with pictorialIDs, and only 24% correct with generic icons, a significant difference (p=0.017, heteroscedastic). In the second task, users searched for a card, as in the file search task of Study 1, except that the card was specified by its “content” (the associated country) rather than by name. In this task users with pictorialIDs averaged 8 correct selections out of 20, versus 2.08 correct for the generic condition, p=0.007.

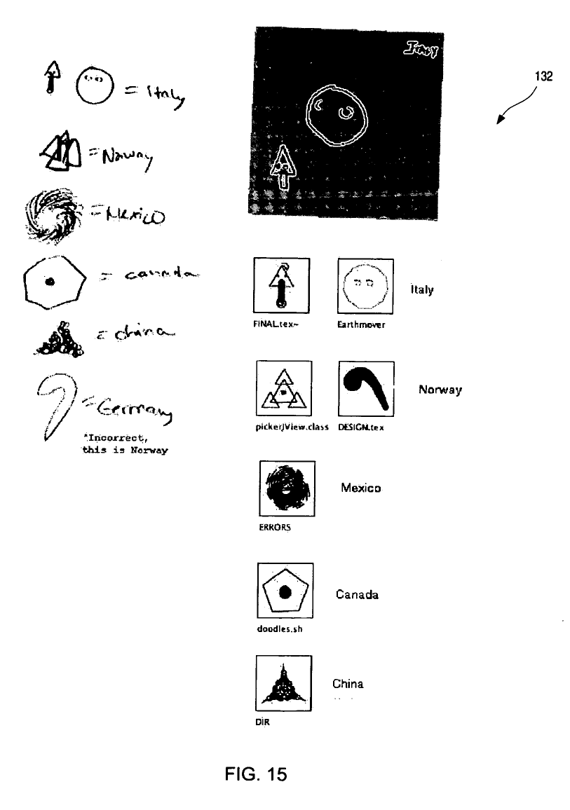

Several subjects were asked to sketch and describe icons from memory two days later. They produced reasonable sketches 132, as shown in FIG. 14, and reasonable descriptions such as “a triangle with two eyes on a stick is Italy” as shown in FIG. 15.

Approximately six weeks following this study accessible group of four of the former subjects were shown a printed page containing a 4×4 grid of icons, nine of which they had seen six weeks previously. All were more than 80% correct in identifying the previously seen icons.

The results of the studies are summarized in the following table:

| | generic | |
|---|---|---|
| | icons | pictorialIDs |
| study1: mean search time | 30.5 secs. | 23.2 secs. |
| study2: label-to-content(percent correct) | 24% | 37% |
| study2: content-to-label (correct/total) | 2.08/20 | 8/20 |

PictoriallDs do not require a radical change to current desktop interfaces, and they complement existing research on spatial navigation schemes. The experimental results are both strong and easily obtainable. The potential efficiency demonstrated here (e.g. a 30% increase in search speed after only a few minutes of use) is most advantageous.

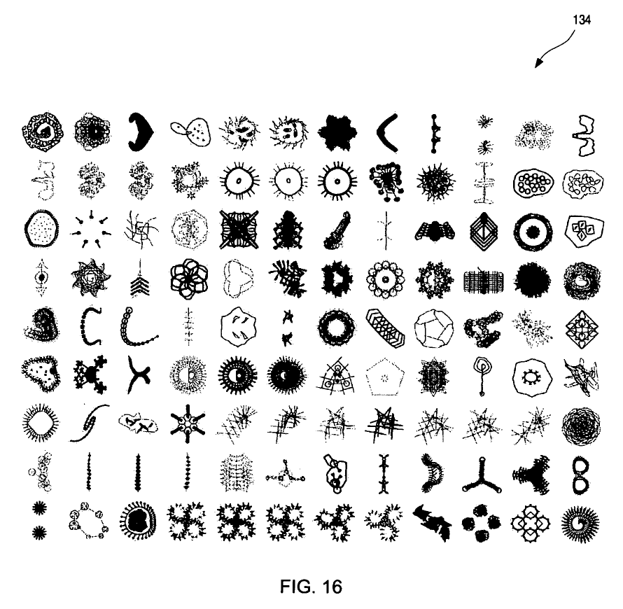

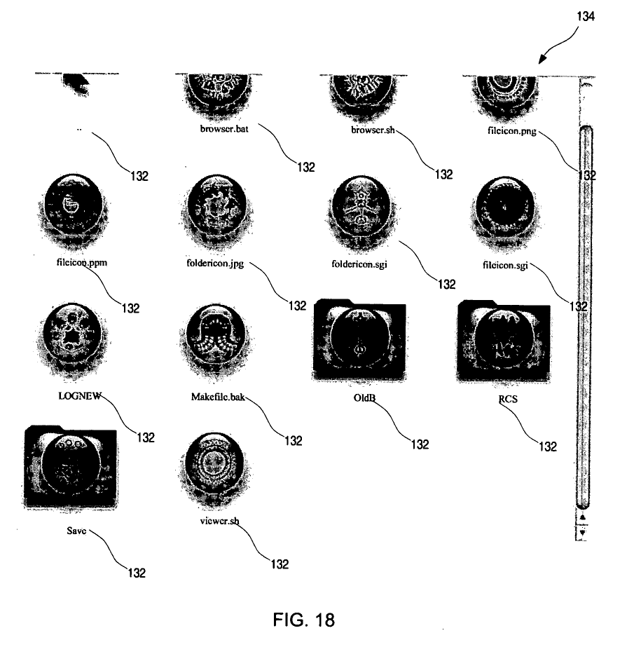

In FIGS. 16, 17 and 18 more doodle-style pictorialIDs 132 are shown. The maximum recursion level is increased to generate more detailed icons. Clustered filenames appear together, but overall order is arbitrary due to traversing a hash table.

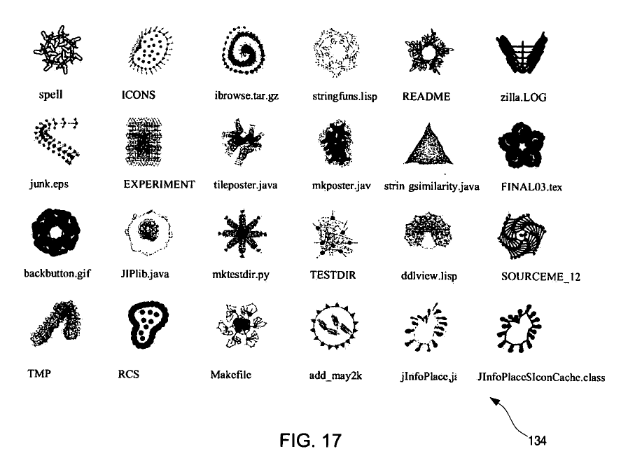

It is preferred that pictorialIDs 132, such as those in browser 134 of FIG. 17, should be persistent. Namely, they should retain a fixed location and appearance until moved by the user. In browser 134 the pictorialIDs 134 have been given a 3D appearance.

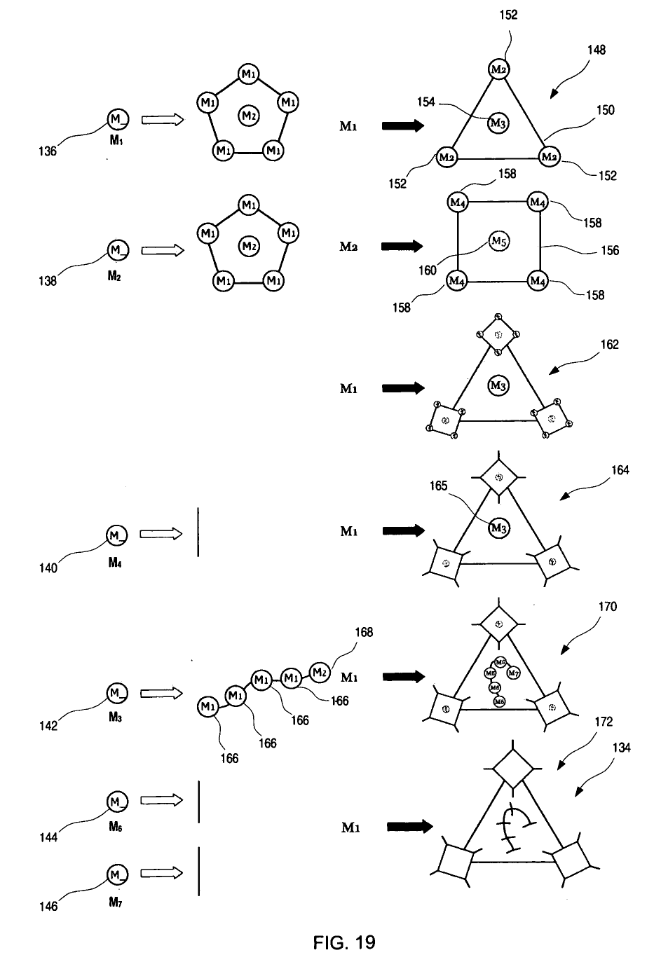

Referring to FIG. 19 there is shown a pictorial identifier 134 being generated according to an embodiment of the invention. The pictorial identifier is generated according to six grammar rules 136, 138, 140, 142, 144 and 146. The first grammar rule 136 has a radial instance that generates a first derivation 148 consisting of a equilateral triangle 150 from a solitary M₁ marker having M₂ markers 152 at each vertex of the triangle 150 and an M₃ 154 marker centrally located therebetween.

The second grammar rule 138 has a radial instance that generates a square 156 from each M₂ marker, the square 156 having M₄ markers 158 at each vertex and a M₅ marker 160 centrally located therebetween. According to the grammar rule 138 the M₅ marker 160 is replaced by null. While this comprises part of the grammar rule 138, it is shown in the FIG. 19 by the M₅ marker being grey in color. The grammar rule 138 includes a rotation rule such that when the grammar rule 138 is applied to the first derivation 148, a second derivation 162 having three lines of symmetry is produced. Given that there were 3 M₂ markers in the first derivation 148, 12 M₄markers and 5 null M₅ markers are provided in the second derivation 162. M₃ and M₄ markers remain to be rewritten.

The third grammar rule 140 has an instance which replaces each M₄ marker with a line. The grammar rule 140 comprises a rotation rule which preserves symmetry so as to operate on the second derivation 162 to provide a third derivation 164.

The fourth grammar rule 142 has an instance which replaces each M₃ marker 165 in the third derivation 164 with a path consisting of four M₁ markers 166 and one M₂ marker 168. The grammar rule 142 is further configured to operate on the M₃ marker 165 of the third derivation 164 to provide an inverted “J”. Thus grammar rule 142 generates a fourth derivation 170.

The fifth and sixth grammar rules 144 and 146 respectively replace M₆ and M₇ markers with a line terminal rule. The final derivation 172 generated thus comprises pictorial identifier 134. In operation the grammar 136 o 146 rules are chosen according to a seed generated from each name identifier. The generation of the seed is divergent in the sense that pictorial identifiers resemble pictorial identifiers generated from substantially similar name identifiers and are visually different from pictorial identifiers generated from substantially different name identifiers.

The distinctive visual appearance of the computer objects may be assigned directly to the data itself or to the space around the data and the scenery may take have 2D or 3D appearance. The approach of assigning appearance directly to the data is arguably more effective than placing scenery around the data. By assigning appearance to the data, “places spatial locations are provided” for simply by the user recognizing the objects in those places.

Pictorial identifiers should be tuned for the human visual system. Some psychological studies have shown an inverted-U curve of image preference as a function of complexity, i.e., a preference for intermediate complexity, with complexity being defined as the number of vertices in random polygons.

The noise image resulting from randomly chosen pixels is maximally complex from entropy and algorithmic complexity points of view, yet such images are not perceptually very distinct, human observers are unable to see the complexity in these images. Thus, it is preferred that the pictorial identifiers be of intermediate rather than the highest possible complexity.

Scenery should be as distinguishable as possible, not just under close examination but also in an overview in which many data items are visible and each is small. This indicates that distinctive detail should be generated across a range of scales, which in turn suggests a scale-recursive construction. The range of scales should include icon and thumbnail scales as would be shown on a computer display.

It is noted that computer users tend to organize their work into directories or folders containing from dozens up to perhaps several hundred items each, while on the other hand existing data spaces contain many thousands or millions of items. On this basis a desirable modelling approach should be able to synthesize very large numbers of distinct icons of which subsets of several hundreds of icons should be distinguishable at a glance and without study.

In the real world one may select a good restaurant by reputation without knowing its appearance, but on a second visit one may find it again having easily learned its appearance. Similarly, one cannot always guess the appearance of a book due to arrive in the mail from knowledge of its subject matter, but its somewhat arbitrary appearance is almost instantly learned and remembered once it is seen. One proviso is however, that a book usually “looks like a book” despite its variable appearance.

The main point is that one does not need appearance to be consistently correlated with anything in order for recognition. Scenery is presented as a fait accompli and the human memory being setup to rapidly learn this somewhat arbitrary mapping between appearance and content.

By being based on visual cues is faster than searching for the name of that object among a wide variety of other names can be provided. Textual strings such as filenames generally serve as the ultimate identifier of digital objects and a filename generally represents the meaning of the file to the user while this meaning often cannot be formally determined from the contents of the data. For example, consider the three filenames NIHfall, NIHfall cover, NIHold containing respectively a report, a corresponding cover letter, and a backup copy of an earlier version of the report. Content analysis would find the two versions of the report to be more similar than the report and the cover letter, but in the user's mind the report and its cover letter belong together as indicated by similar naming.

According to the embodiment described objects with similar file names generally have similar visual identifiers. Contrasting the datavizualisation by thumbnails reflecting content and the pictorialIDs as generated according to the embodiment results in the following table.

| data visualization (thumbnails) | visual identifiers |
|---|---|
| functional icons | memorable icons |
| distinguishability is a secondary | distinguishability essential |
| design goal | |
| icons reflect data content | reflecting content is secondary |
| appearance changes according to need | appearance is fairly permanent |

The complete parameters for the shape grammar are described below for reference.

In the parameter descriptions:
level is the recursion level, starting at 1 and increasing with smaller scale detail.
Rnd11( ) returns a uniform pseudo-random value in −1,1.
mdinLowbias(a,b,p) is a version of the low-bias generator where the power can be specified: a+(b−a)*pow(Rnd( ),p).
rational(lo,hi,den) returns a rational number (cast to real) where the numerator is in lo,hi and the denominator is den.
mdprobLevel(p): The probability is reduced at each level using p=p−p*min(level, 5)/6
mdinLevel(a,b): the range is reduced by recursion level, i.e., a+Rnd( )*(b−a)/level.

Around-a-spiral

| | | |
|---|---|---|
| len | rndin(25, 60) | number of segments in |
| | | the spiral (if level = 1) |
| len | rndin(10, 30) | number of segments in |
| | | the spiral (if level = 2) |
| len | rndin(5, 10) | number of segments in |
| | | the spiral (if level = 3) |
| len | 5 | number of segments in |
| | | the spiral (if level > 3) |
| aligned | rndprob(0.5) | children are aligned on |
| | | radial spokes |
| ppr | rndinLowbias(3, 35) | points per revolution |
| | | (if aligned) |
| ppr | rational(3, 35, rndin(3, 7)) | points per revolution |
| | | (if not aligned) |
| hasChild | rndin(0.5, 1) | place a child generator |
| | | at points along the spiral |
| centerScale | rndin(0.05, 0.6) | scale reduction for the |
| | | child at center of spiral |
| outerScale | rndin(0.25, 1) | scale reduction for the |
| | | child at outside of spiral |

The spiral algorithm is

for( i=0; i < len; i++ ) {

theta = 2*pi*float(i) / ppr;

r = 0.15 * sqrt(theta);
x = r * cos(theta);
y = r * sin(theta);

}

The ppr is adjusted so that there are at least two revolutions in the spiral.

Around-a-Shape and Relaxed Inside

Both of these are implemented with the same code, with a boolean variable hasOC controlling whether a child is generated around the outline.

The outline is created with either a Fourier series or FFT filtering of noise, according to the variable fourier. Fourier series generation produces a more regular or coherent outline. Pseudocode for the Fourier series is:

ncoef = 2*rndin(2,5) + 1;
for( i = 0; i < ncoef; i++ )
amp[i] = Rnd11( ) / float(i+1); // 1/f envelope

| | | |
|---|---|---|
| n | rndinLevel(3, 6) | number of objects (power) |
| fourier | rndprob(0.5) | use fourier series (else FFT) |
| exponent | rndin(1.6, 2.2) | spectral exponent for FFT filtering |
| hasIC | rndprobLevel(0.6) | a child is placed inside the outline |
| hasOC | rndprobLevel(0.6) | a child is placed around the outline |
| OCscale | rndin(0.1, 0.6) | scale reduction for the outline child |

The number of interior children is 2ⁿ, and each child is scaled down by mdin(0.1,2)/2ⁿ.

Along a Path

The outline is created with either a Fourier series or FFT filtering of noise, according to the variable fourier. The code is similar to that for the relaxed inside generator, except that a subrange of the synthesized outlines between parameter 0,0.7 is used to produce an open, a periodic curve, whereas relaxed inside uses the full 0,2*pi range of the outline. The number of children placed along the curve is 2n.

| | | |
|---|---|---|
| hasChild | rndproblevel(0.8) | place child along the path |
| Cscale | rndin(0.1, 0.6) | child scale reduction |
| n | rndinLevel(3, 6) | (power) number of children placed |
| | | along the path |
| fourier | rndprob(0.5) | use Fourier series synthesis |
| exponent | rndin(1.6, 2.2) | spectral exponent for FFT filtering |

Scribble

The scribble generator traces a path attracted by random or patterned attractors and damped by “friction”. In the random case attractors are randomly distributed throughout the unit square centered on the origin. Patterned attractors X[i], Y[i] are distributed in a “zig-zag” pattern according to the code:

float dx = 0.f;
float dy = 1.f;
float cx = 0.f;
float cy = −0.5f;
float opposingRatio = rndin(0.05f, 0.2f);
for( int i=0; i < ncvs; i++ ) {

X[i] = cx;
Y[i] = cy;
if (i%2 == 0) {

cx = cx + dx;
cy = cy + dy;

}
else {

cx = cx − dx;
cy = cy − dy;

| } | |
|---|---|
| // move perpendicular | |
| cx = cx − opposingRatio *−dy | |
| cy = opposingRatio * | dx; |

} //for

The attractors are applied in sequence, with a new attractor taking effect when the line has approached a preset distance (0.03) from the current attractor. The attractor force is in the direction from the current point to the attractor. The scribble algorithm is best described in code:

| float jitter = 0.1f; | |
|---|---|
| float dx = X[1] − X[0]; | // X, Y are the attractor locations |
| float dy = Y[1] − Y[0]; | |
| dx = dx + jitter * rndf11( ); | |
| dy = dy + jitter * rndf11( ); | |

float len = (float)sqrt(dx*dx + dy*dy);
float distthresh = 0.03f;
float force = 0.01f;
float cx = X[0];
float cy = Y[0];
float vx = 0.f;
float vy = 0.f;
int ncvs = X.length;
moveto(cx, cy); // use moveto/lineto drawing
for( int icv=0; icv < ncvs; icv++ ) {

int icv1 = (icv + 1) % ncvs;
float spandx = X[icv1] − X[icv];
float spandy = Y[icv1] − Y[icv];
float dot = 1.f;
boolean flag = true;
while(flag) {

```
// integration
force = (len > 0.2f) ? (force*1.1f) : (force*0.7f);
if (force > 0.08f) force = 0.08f;
  if (force < 0.01f) force = 0.01f;
vx = vx + force * dx;
vy = vy + force * dy;
vx = vx * _friction;
vy = vy * _friction;
cx = cx + vx;
cy = cy + vy;
lineto(cx, cy);
// new direction
dx = X[icv1] − cx;
dy = Y[icv1] − cy;
len = (float)sqrt(dx*dx + dy*dy);
dx = dx + (float)abs(dx)*jitter*rndf11( );
dy = dy + (float)abs(dy)*jitter*rndf11( );
// end segment?
dot = spandx*dx + spandy*dy;
  if (len < distthresh)
```

// near attractor, break
flag = false;

} //while(flag)

} //icv

| | | |
|---|---|---|
| zigzag | rndprob(0.5) | zig-zag patterned impulses (else random) |
| n | rndin(2, 30) | if !zigzag and level = 1 |
| n | rndin(10, 20) | if !zigzag and level > 1 |
| n | rndin(40, 10) | if zigzag |
| friction | rndin(0.85, 0.98) | if !zigzag |
| friction | rndin(0.8, 0.9) | if zigzag |

Symmetry

The symmetry generator draws nothing itself but applies its child in an n-lateral radial symmetry. If n=2 the child is mirrored.

| | | |
|---|---|---|
| n | rndinLevelLowbias(2, 8) | n-lateral symmetry |
| offset | rndprob(0.3) | translate out from |
| | | center |
| offsetTrans | rndin(0.1, 0.5) | amount to translate |
| | | out from center |
| Cscale | rndin(0.3, 0.6)*(1-offsetTrans) | child scale reduction |

Line Generator

Although line serves as a terminal in the grammar we also use it as a non-terminal with these parameters:

| | | |
|---|---|---|
| len | rndin(0.5, 1) | length of the line |
| n | rndinLowbias(3, 10, 1.5) | number of C3 children |
| | | along the line |
| hasEC1 | rndprob(0.75) | has child C1 at end 1 |
| hasEC2 | rndprob(0.75) | has child C2 at end 2 |
| hasC3 | rndprob(0.5) | has child 3 (along the line) |
| C1scale | rndin(0.15, 0.6) | scale reduction for child 1 |
| C2scale | rndin(0.15, 0.6) | scale reduction for child 2 |
| C3scale | rndinLowbias(0.05, | scale reduction for child 3 |
| | 0.7, 1.5) | |
| C3doublesided | rndprob(0.8) | child 3 is drawn mirrored |
| | | on both sides |
| C3angle | rndin(−pi/4, pi/4) | angle of child3 relative |
| | | to line normal |
| C3taper | rndprob(0.3) | reduce or increase scale |
| | | of child3 by 1.5 along |
| | | the line |
| C3increase | rndprob(0.3) | increase (rather than |
| | | decrease) child3 scale |
| | | along line |

Figure Generator

The figure generator produces an animal-like arrangement of generators. Most generators are forced to be line, while the “head” is allowed to be a line or radial.

| | | |
|---|---|---|
| art | rndin(0.1, 0.2) | scale reduction for the head child |
| legScale | rndin(0.3, 0.6) | scale reduction for the leg children |
| tailScale | rndin(0.1, 0.4) | scale reduction for the “tail” child |

Throughout the specification, unless the context requires otherwise, the word “comprise” or variations such as “comprises” or “comprising”, will be understood to imply the inclusion of a stated integer or group of integers but not the exclusion of any other integer or group of integers.

Thus the scope of the present invention should not be limited to the specific examples of the foregoing description, but rather is indicated by the appended claims and their legal equivalents.

What is claimed is:

1. A method of generating a pictorial identifier for a computer object, the method comprising: generating a pictorial identifier according to a modelling approach based on at least a part of a textual identifier of the computer object; wherein the part of the textual identifier is not tied to any type identifiers associated with the computer object and the modelling approach is generally characterised by generating pictorial identifiers that are visually different from pictorial identifiers generated from substantially different textual identifiers.

2. The method as claimed in claim 1 wherein the part of the textual identifier comprises part of a name identifier of the computer object and/or part of the content of the computer object, said parts not being tied to a type identifier associated with the computer object.

3. The method as claimed in claim 1 wherein the modelling approach is generally characterised by generating pictorial identifiers resembling pictorial identifiers generated from substantially similar textual identifiers.

4. The method as claimed in claim 3 wherein the level of similarity between textual identifiers needed to generate a similar pictorial identifier is controlled by an adjustable threshold.

5. The method as claimed in claim 1 wherein the modelling approach is based on the part of the textual identifier as well as a part of the textual identifier tied to a type identifier associated with the computer object.

6. The method as claimed in claim 5 wherein the modelling approach involves determining which computer applications are associated with the type identifier so that the similarity arising from textual identifiers being tied to type identifiers associated with similar computer applications is recognised by the modelling approach.

7. The method as claimed in claim 6 wherein determining which computer applications are associated with the type identifier includes querying a file type association module.

8. The method as claimed in claim 1 wherein the modelling approach is based on the entire textual identifier.

9. The method as claimed in claim 1 including proactively generating pictorial identifiers according to the modelling approach upon textual identifiers of computer objects being modified or created.

10. The method as claimed in claim 1 including generating pictorial identifiers for a plurality of computer objects according to the modelling approach, upon the user opening a directory structure containing the objects.

11. The method as claimed in claim 1 wherein the modelling approach is further characterised by generating pictorial identifiers of intermediate complexity.

12. The method as claimed in claim 1 wherein the modelling approach is further characterised by generating pictorial identifiers that are distinctive on an overview scale and a thumbnail scale.

13. The method as claimed in claim 1 including sorting a plurality of textual identifiers into sub-groups according to the similarity of the textual identifiers, the modelling approach being additionally based on the structure of the sub-groups.

14. The method as claimed in claim 13 wherein sorting involves determining the closest match among the textual identifiers and creating a new sub-group if the distance between the closest match and the textual identifier is greater than a threshold.

15. The method as claimed in claim 13 wherein generating involves mutating a pictorial identifier associated with the sub-group into which the textual identifier of the computer object has been sorted.

16. The method as claimed in claim 1 wherein the modelling approach is further characterised by generating pictorial identifiers such that they comprise a plurality of line segments.

17. A method of associating a pictorial identifier with a computer object comprising:
processing at least a part of a textual identifier of the computer object, wherein the part of the textual identifier is not tied to any type identifiers associated with the computer object; and
associating a pictorial identifier with the computer object such that the pictorial identifier is visually different from pictorial identifiers associated with substantially different textual identifiers of other computer objects.

18. The method as claimed in claim 17 wherein the modelling approach is based on the part of the textual identifier as well as a part of the textual identifier tied to a type identifier associated with the computer object.

19. The method as claimed in claim 17 wherein the pictorial identifier resembles pictorial identifiers associated with substantially similar textual identifiers of yet other computer objects.

20. The method as claimed in claim 19 wherein the level of similarity between textual identifiers needed to generate a similar pictorial identifier is controlled by an adjustable threshold.

21. The method as claimed in claim 17 wherein the modelling approach involves determining which computer applications are associated with the type identifier so that the similarity arising from textual identifiers being tied to type identifiers associated with similar computer applications is recognised by the modelling approach.

22. The method as claims in claim 17 wherein the modelling approach is based on the entire textual identifier.

23. The method as claimed in claim 17 including proactively generating pictorial identifiers according to the modelling approach upon textual identifiers of computer objects being modified or created.

24. The method as claimed in claim 17 wherein the modelling approach is further characterised by generating pictorial identifiers such that they comprise a plurality of line segments.

25. A method of generating a pictorial identifier for a computer object, the method comprising: generating a pictorial identifier according to a modelling approach based on at least a part of a file name preceding a file name extension associated with the computer object, the modelling approach being generally characterised by generating pictorial identifiers resembling pictorial identifiers generated from substantially similar name identifiers and being visually different from pictorial identifiers generated from substantially different name identifiers.

26. The method as claimed in claim 25 wherein the file name extension comprises a type identifier consisting of a file name suffix in the form “.*”, where the asterisk represents any number of acceptable characters excluding the period symbol.

27. The method as claimed in claim 25 wherein the pictorial identifier is generated based on the entire file name which file name includes the file name extension.

28. The method as claimed in any one of claim 25 including proactively generating pictorial identifiers according to the modelling approach upon name identifiers of computer objects being modified or created.

29. The method as claimed in claim 25 including generating pictorial identifiers for a plurality of computer objects according to the modelling approach, upon the user opening a directory structure containing the objects.

30. The method as claimed in claim 25 including sorting a plurality of name identifiers into sub-groups according to the similarity of the name identifiers, the modelling approach being additionally based on the structure of the sub-groups.

31. The method as claimed in claim 30 wherein sorting involves determining the closest match among the name identifiers and creating a new sub-group if the distance between the closest match and the name identifier is greater than a threshold.

32. The method as claimed in claim 30 wherein generating involves mutating a pictorial identifier associated with the sub-group into which the name identifier of the computer object has been sorted.

33. The method as claimed in claim 25 wherein the modelling approach is further characterised by generating pictorial identifiers such that they comprise a plurality of line segments.

34. A method comprising: providing a pictorial identifier generated according to a modelling approach based on at least a part of a textual identifier of the computer object; wherein the part of the textual identifier is not tied to any type identifiers associated with the computer object and the modelling approach is generally characterised by generating pictorial identifiers resembling pictorial identifiers generated from substantially similar textual identifiers and being visually different from pictorial identifiers generated from substantially different textual identifiers.

35. The method as claimed in claim 34 wherein the pictorial identifier is provided on a display.

36. The method as claimed in claim 34 including sorting a plurality of textual identifiers into sub-groups according to the similarity of the textual identifiers, the modelling approach being additionally based on the structure of the sub-groups.

37. The method as claimed in claim 36 wherein sorting involves determining the closest match among the textual identifiers and creating a new sub-group if the distance between the closest match and the textual identifier is greater than a threshold.

38. The method as claimed in claim 36 wherein generating involves mutating a pictorial identifier associated with the sub-group into which the textual identifier of the computer object has been sorted.

39. A system for generating a pictorial identifier for a computer object, the system comprising:
means for generating a pictorial identifier according to a modelling approach based on at least a part of a textual identifier of the computer object, the part of the textual identifier not being tied to any type identifiers associated with the computer object; and
means for ensuring that the pictorial identifier generated is visually different from pictorial identifiers generated from substantially different textual identifiers.

40. The system as claimed in claim 39 wherein the modelling approach is based upon on the part of the textual identifier as well as a part of the textual identifier tied to a type identifier associated with the computer object.

41. The system as claimed in claim 39 wherein the means for ensuring ensures that the pictorial identifier generated resembles pictorial identifiers generated from substantially similar textual identifiers.

42. The system as claimed in claim 41 including threshold means for controlling the level of similarity between textual identifiers needed to generate a similar pictorial identifier, according to an adjustable threshold.

43. The system as claimed in claim 39 including means for determining which computer applications are associated with the type identifier so that the similarity arising from textual identifiers being tied to type identifiers associated with similar computer applications is recognised by the modelling approach.

44. The system as claimed in claim 39 wherein the modelling approach is based on the entire textual identifier.

45. The system as claimed in claim 39 wherein the means for determining comprises means for querying a file type association module.

46. The system as claimed in claim 39 including means for proactively generating pictorial identifiers according to the modelling approach, upon textual identifiers of computer objects being modified or created.

47. The system as claimed in claim 39 including generating pictorial identifiers for a plurality of computer objects according to the modelling approach, upon the user opening a directory structure containing the objects.

48. The system as claimed in claim 39 wherein the means for generating is characterised by generating the pictorial identifiers of intermediate complexity.

49. A system as claimed in claim 39 wherein the means for generating is characterised by generating pictorial identifiers that are distinctive on a thumbnail scale and an icon scale.

50. A system as claimed in claim 39 including means for sorting a plurality of textual identifiers into sub-groups according to the similarity of the textual identifiers, the means for sorting being coupled to the means for generating such that the pictorial identifier generated is based on the structure of the sub-groups.

51. A system as claimed in claim 50 wherein the means for sorting includes means for determining the closest match among the textual identifiers and mean for creating a new sub-group if the distance between the closest match and the textual identifier is greater than a threshold.

52. A system as claimed in claim 50 including means for mutating a pictorial identifier associated with the sub-group into which the textual identifier of the computer object has been sorted.

53. A system as claimed in claim 39 wherein the means for generating is characterised by generating the pictorial identifier such that the identifier comprises a plurality of line segments.
